(19) United States
(12) Patent Application Publication
(10) Pub. No.: US 2010/0214738 A1
(43) Pub. Date: Aug. 26, 2010

(54) PORTABLE ELECTRONIC DEVICE AND DISSIPATING STRUCTURE THEREOF

(76) Inventor: Duying WANG, Kunshan Export Processing Zone (CN)

Correspondence Address: Muncy, Geissler, Olds & Lowe, PLLC, 4000 Legato Road, Suite 310, FAIRFAX, VA, 22033, US

(21) Appl. No.: 12/624,131

(22) Filed: Nov. 23, 2009

Related U.S. Application Data
(60) Provisional application No. 61/155,453, filed on Feb. 25, 2009.

(51) Int. Cl. G06F 1/20

(52) U.S. Cl. 361/679.48

(57) ABSTRACT

Disclosed herein is a portable electronic device including a main body and a fan. The main body includes two opposite first and second lateral housing surfaces. The first lateral housing surface includes a first air outlet, and the second lateral surface comprising a first air inlet. The fan is disposed within the main body and includes a ventilation outlet and a ventilation inlet. The space layout within the main body includes at least an air channel interconnected between the air inlet and the ventilation inlet, wherein the air channel includes an second air inlet and an second air outlet; furthermore an cross-section of the second air inlet is smaller than an cross-section of the second air outlet.

### CROSS-REFERENCE TO RELATED APPLICATION

This application claims the priority benefit of U.S. Provisional Application Ser. No. 61/155,453, filed Feb. 25, 2009, the full disclosures of which are incorporated herein by reference.

### BACKGROUND

1. Field of Invention

The present invention relates to a heat dissipation structure. More particularly, the present invention relates to a heat dissipation structure of a portable electronic device.

2. Description of Related Art

A portable electronic device has an even better computing performance now, but its major computing integrated circuit (such as CPU or Graphics chip) produces more and more heat. When too much heat within the portable electronic device cannot be properly dissipated, not only is the performance of the portable electronic device diminished but also the users feel uncomfortable due to heat.

A conventional solution is to increase forced convection within the portable electronic device by installing a fan, and design ventilation holes on the bottom and lateral housing surface so as to form a “bottom in and lateral out” forced convection. Such heat dissipation way is applicable for portable computers which are often put on a desk, but is inapplicable for portable computers which are often put on a user's lap. When portable computers are put on a user's lap, the ventilation holes on bottom housing will be easily blocked to prevent air entry such that the heat within the portable electronic device cannot be properly dissipated.

For the forgoing reasons, there is a need for improving a heat dissipation structure of a portable electronic device.

### SUMMARY

According to one aspect of this invention, a portable electronic device is provided to include a main body and a fan. The main body includes two opposite first and second lateral housing surfaces. The first lateral housing surface includes an air outlet, and the second lateral housing surface comprising an air inlet. The fan is disposed within the main body and includes a ventilation outlet and a ventilation inlet. The space layout within the main body includes at least an air channel interconnected between the air inlet and the ventilation inlet, the air channel comprises an second air inlet and an second air outlet, wherein an cross-section of the second air inlet is smaller than an cross-section of the second air outlet.

According to another aspect of this invention, a portable electronic device is provided to include a main body, a plurality of heat-generating components, an air guide module and a fan. The main body includes two opposite first and second lateral housing surfaces. The first lateral housing surface includes an air outlet, and the second lateral housing surface comprising an air inlet. The heat-generating components are disposed within the main body. The air guide module is disposed between the heat-generating components and air inlet to direct inlet air to the heat-generating components. The fan is disposed within the main body and includes a ventilation outlet and a ventilation inlet. The space layout within the main body includes at least an air channel interconnected between the air inlet and the ventilation inlet.

Thus, the portable device with a “lateral in and lateral out” forced convection prevents the disadvantages caused by “the ventilation holes on bottom housing surface being easily blocked”. The bottom housing surface can be designed without any ventilation hole and waterproof. Besides, the component arrangements within the main body make the forced convection better and temperature distribution uniform so as to avoid hot spots.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a portable electronic device according to one embodiment of this invention;

FIG. 1A illustrates a perspective view of the portable electronic device in FIG. 1 with part of upper housing removed;

FIG. 2 illustrates a side view of the portable electronic device in FIG. 1;

FIG. 3 illustrates another side view of the portable electronic device in FIG. 1;

FIG. 4 illustrates a cross-sectional view taken along A-A′ in FIG. 1;

FIG. 5A illustrates a perspective view taken along B-B′ in FIG. 1;

FIG. 5B illustrates a similar perspective view taken along B-B′ in FIG. 1 with a thinner component 112; and

FIG. 6 illustrates a cross-sectional view taken along C-C′ in FIG. 1.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

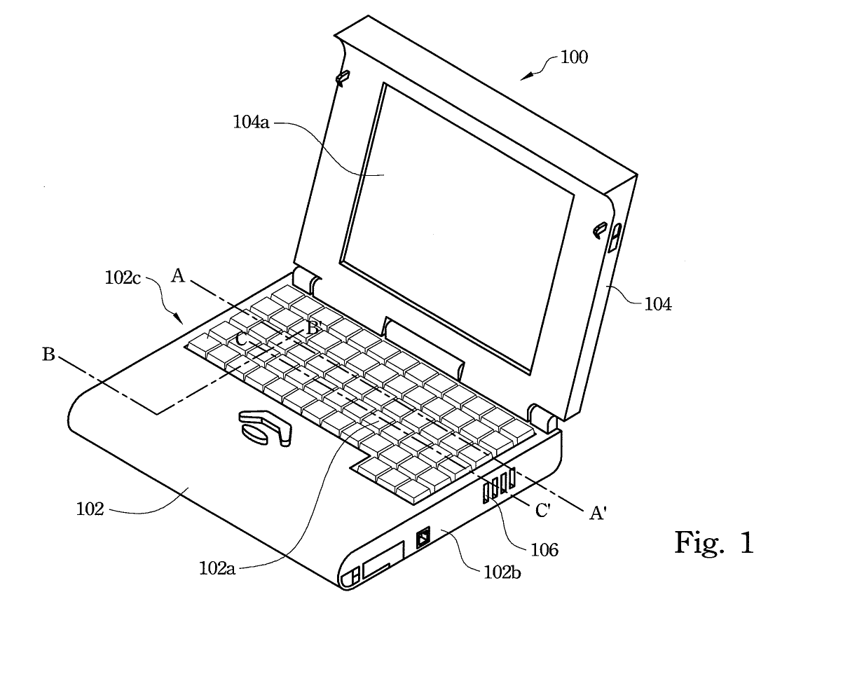

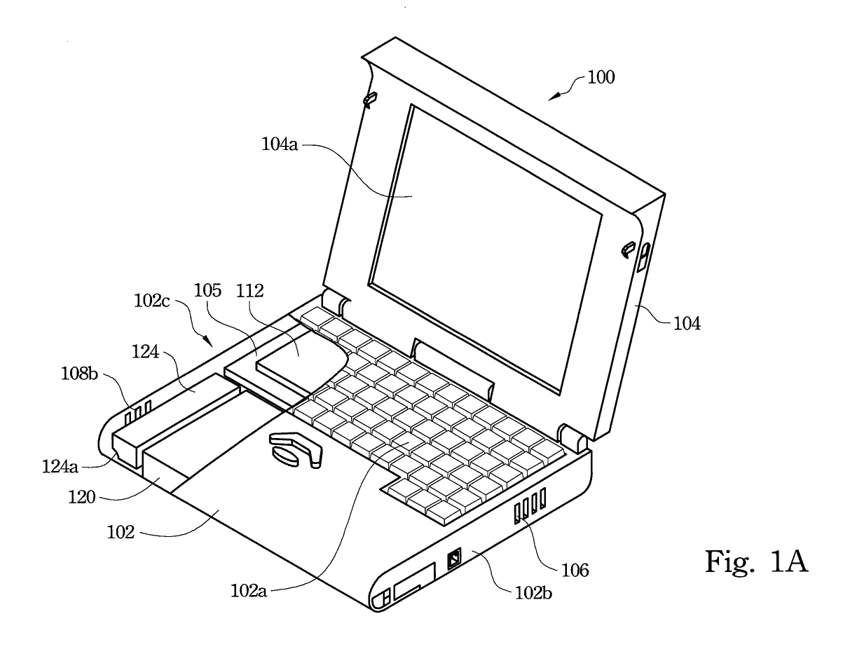

FIG. 1 illustrates a perspective view of a portable electronic device according to one embodiment of this invention. A portable electronic device 100 in FIG. 1 can be a notebook computer or a tablet computer of large size or small size. The portable electronic device 100 includes a main body 102 and a display portion 104. The display portion 104 is pivotally connected with the main body 102 such that the display portion 104 can be rotated relative to the main body 102 to be laid against the main body 102 or form an included angle therebetween. The display portion 104 has a display screen 104a for outputting information whereas the main body 102 has a keyboard 102a for inputting information. The portable electronic device 100 can also be a body equipped with a touch panel as its only input and output channel, but not divided into a main body and a display portion (not illustrated in the drawings).

In an embodiment of this invention, the main body of the portable electronic device is equipped with ventilation holes on two opposite lateral housing surface so as to form a “lateral in and lateral out” forced convection. Because all ventilation holes are designed on lateral housing surfaces, there is no such case as “the ventilation holes on bottom housing surface being easily blocked”.

As illustrated in FIG. 1, ventilation holes are designed on two opposite lateral housing surfaces (102b, 102c) of the main body 102. In particular, the two opposite lateral housing surfaces (102b, 102c) are respectively right-handed side and left-handed side of a user when the user sits in front of the display screen 104a.

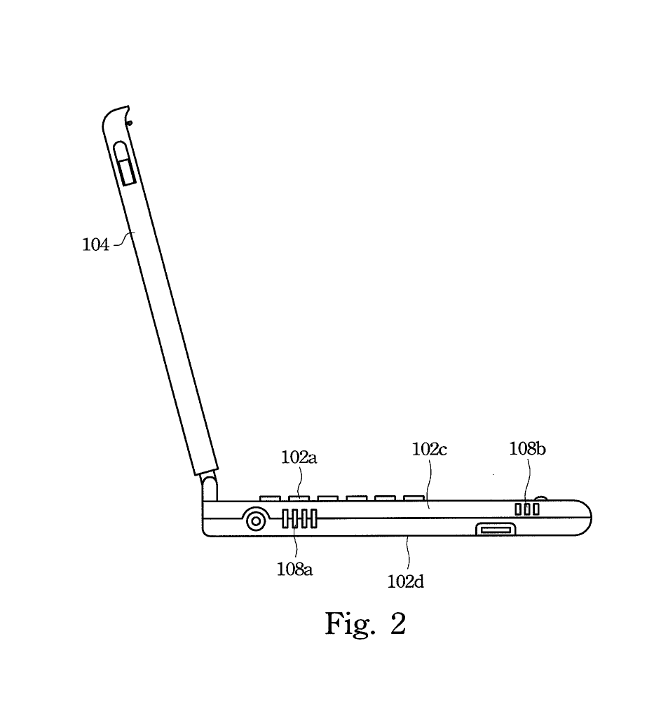

FIG. 2 illustrates a side view of the portable electronic device in FIG. 1, which illustrate the lateral housing surface 102c. The housing surface 102c has two groups of air inlets (108a, 108b). The bottom surface 102d is not equipped with any ventilation holes such that there is no such case as “the ventilation holes on bottom housing surface being easily blocked” and the bottom housing surface can be designed waterproof.

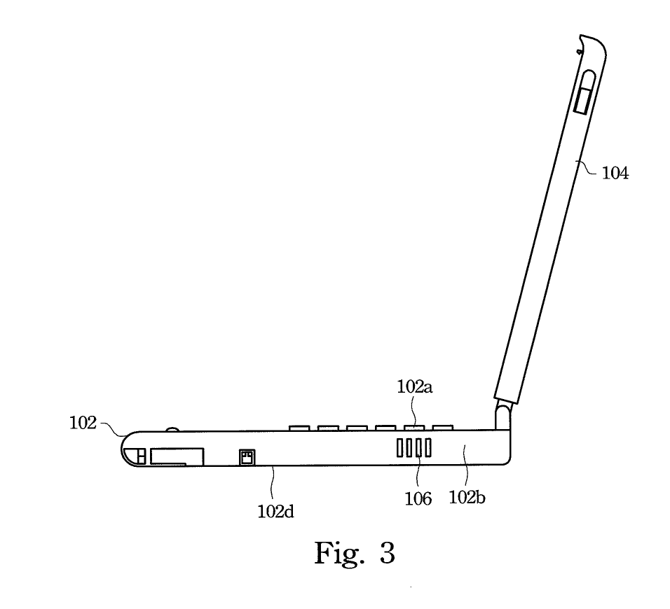

FIG. 3 illustrates another side view of the portable electronic device in FIG. 1, which illustrates the lateral housing surface 102b. The housing surface 102b has a group of air outlets 106. The bottom surface 102d is not equipped with any ventilation holes such that there is no such case as “the ventilation holes on bottom housing surface being easily blocked” and the bottom housing surface can be designed waterproof.

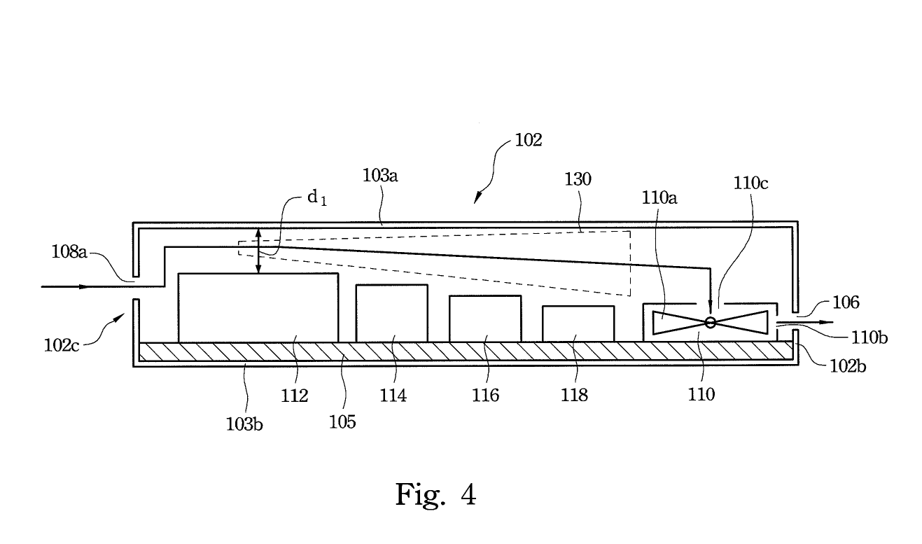

FIG. 4 illustrates a cross-sectional view taken along A-A′ in FIG. 1, which illustrates a cross-sectional view from the inlet 108a to the outlet 106 to show a space layout of the portable electronic device. Because the inlet 108a and the outlet 106 are respectively located on two opposite sides of the main body 102, which is too long to dissipate heat, a fan 110 is hence installed close to the outlet 106 to increase forced convection. The fan 110 can be a centrifugal fan with its ventilation outlet 110b aligned with the air outlet 106. In this embodiment, the fan 110 is closer to the air outlet 106 than the air inlet 108a. The so called “centrifugal fan” means its ventilation inlet 110c is axially located relative to the impeller 110a and its ventilation outlet 110b is radially located relative to the impeller. The arrow as illustrated in FIG. 4 indicates the direction of forced convection, from the air inlet 108a to the ventilation inlet 110c of the fan 110, then from ventilation outlet 110b to the air outlet 106. When the impeller 110a rotates, the forced convection occurs along the arrow direction. A cross-section of the air channel along the arrow direction should have a proper width, wherein a cross-section of the air inlet is smaller than a cross-section of the air outlet. In this embodiment, the width can be d₁, which is the distance between a thickest component 112 and an upper housing wall 103a. The d₁ needs to be at least 0.3 mm such that the forced convection can be achieved efficiently. Within the main body 102, several heat-generating components 112, 114, 116 and 118 can also be properly arranged on the main board 105 such that the temperature can be uniform to avoid hot spots within the main body 102. For example, the relatively thick component 112 can be closer to the air inlet 108a. Specifically, the component 112 is closer to the air inlet 108a than the air outlet 106. The component 112 can be a hard disc or other thick components. Besides, the component 114 which generates relatively more heat can be closer to the air inlet 108a. Specifically, the component 114 is closer to the air inlet 108a than the air outlet 106 such that the component 114 would be heat-dissipated faster with cooler air from the air inlet 108a. The component 114 can be a graphics chip, a south bridge chip, a north bridge chip, a central processing chip or any other chip generating relatively more heat.

In addition, the thickness of the heat-generating components 112, 114, 116 and 118 serially reduces from the air inlet 108a to the air outlet 106 so as to form an air channel with a smaller inlet and a larger outlet. Specifically, the air channel has a smaller inlet cross-section and a larger outlet cross-section, thereby increasing air flowing efficiency.

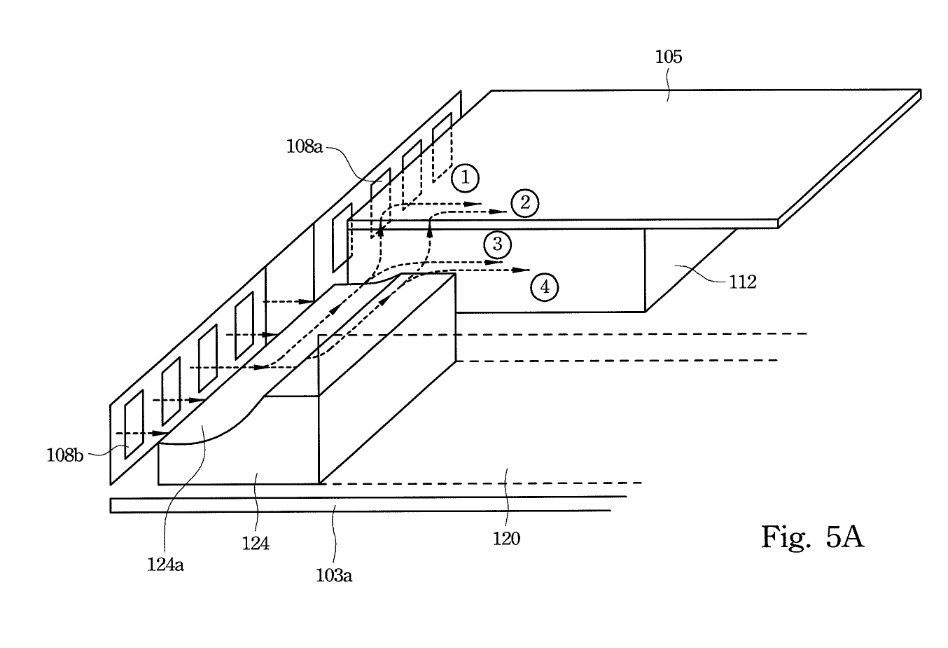

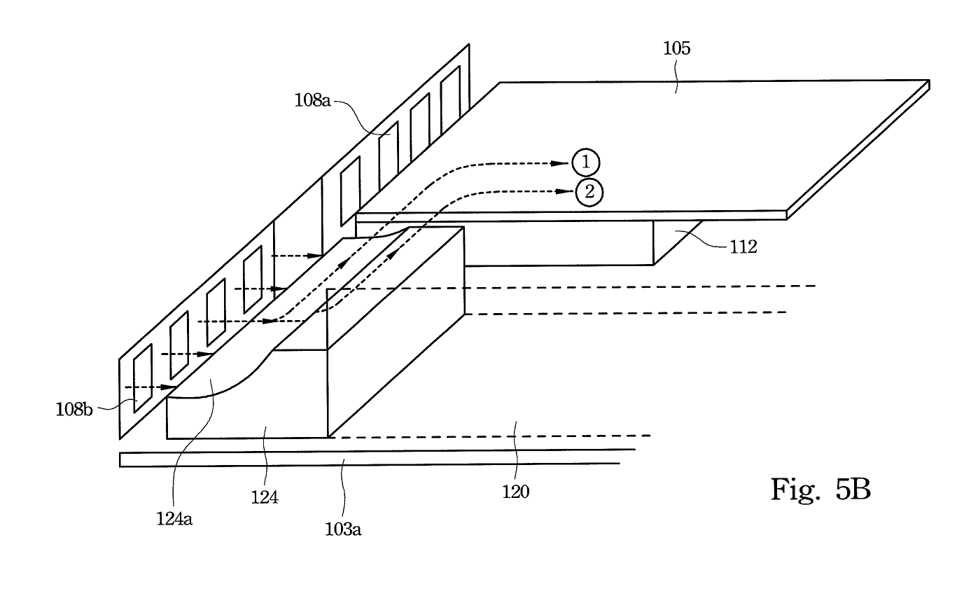

FIG. 5A illustrates a perspective view taken along B-B′ in FIG. 1, which illustrates a perspective view of the main body from the air inlet 108b (this view is upside down compared with FIG. 1).

Referring to both FIG. 1A and FIG. 5A, the air inlet 108b is close to a battery 120. Because the relatively thick battery 120 may prevent air entry from the air inlet 108b and the battery 120 cannot be reshaped, an air guide module 124 is installed between the battery 120 and the air inlet 108b. The air guide module 124 has a guide surface 124a not in parallel with the air inlet 108b so as to smoothly direct the airflow around heat-generating components and divided into four flows towards the back surfaces of the heat-generating components. Airflow 1 passes by the guide surface 124a and turns to the component 112 before bumping into the battery 120, and then goes along a bottom edge of the component 112 towards the fan. Airflow 2 passes by the guide surface 124a and turns to the component 112 after bumping into the battery 120, and then goes along a bottom edge of the component 112 towards the fan. Airflow 3 passes by the guide surface 124a and turns to the component 112 before bumping into the battery 120, and then goes along a sidewall of the component 112 towards the fan. Airflow 4 passes by the guide surface 124a and turns to the component 112 after bumping into the battery 120, and then goes along a sidewall of the component 112 towards the fan. The air guide module 124 can be an antenna device or the other component, which can be reshaped in its profile.

FIG. 5B illustrates a similar perspective view taken along B-B′ in FIG. 1 with a thinner component 112. Because the air guide module 124 is thicker than the component 112, the airflow into the main body is thereby divided into two flows (which is less than four airflows illustrated in FIG. 5A). Airflow 1 passes by the guide surface 124a and turns to the component 112 before bumping into the battery 120, and then goes along a bottom edge of the component 112 towards the fan. Airflow 2 passes by the guide surface 124a and turns to the component 112 after bumping into the battery 120, and then goes along a bottom edge of the component 112 towards the fan.

Although the air guide module 124 only illustrates in “wedge-like” cross-section, the air guide module can be of arc shape, rectangular or other shaped cross-section. The cross-section of the air guide module 124 is not restricted in any specific shape which benefits guiding airflows.

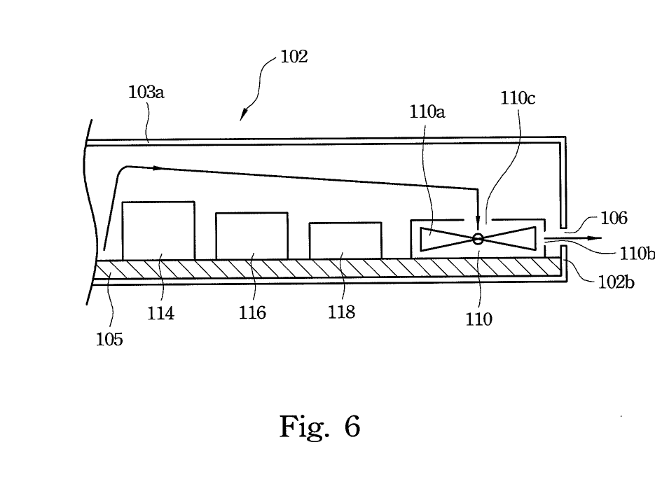

FIG. 6 illustrates a cross-sectional view taken along C-C′ in FIG. 1, which connects FIG. 5A or 5B to illustrate a cross-section to the air outlet 106. Referring also to FIGS. 1A, 5A, 5B and 6, the arrow directions indicate forced convection within the main body 102, specifically, from the air inlet 108b to the air guide module 124, then along a gap between the air guide module 124 and a lower housing wall 103b (referring to above-mentioned airflows 1-4), then to the ventilation inlet 110c of the fan 110 and finally from the ventilation outlet 110b to the air outlet 106. When the impeller 110a rotates, the forced convection occurs along the arrow direction as discussed above.

According to the embodiments illustrated in FIGS. 4, 5A, 5B and 6, the lateral housing surface 102c has two groups of air inlets (108a, 108b) and air-guiding structures are designed on the components closest to the air inlets. Besides, the thickness of the heat-generating components reduces serially from the air inlet to the air outlet so as to form an air channel with a smaller inlet and a larger outlet, thereby increasing air flowing efficiency.

According to discussed embodiments, the portable device with a “lateral in and lateral out” forced convection prevents the disadvantages caused by “the ventilation holes on bottom housing surface being easily blocked”. The bottom housing surface can be designed without any ventilation hole and waterproof. Besides, the component arrangements within the main body make the forced convection better and temperature distribution uniform so as to avoid hot spots therein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable electronic device comprising:
a main body comprising two opposite first and second lateral housing surfaces, the first lateral housing surface comprising a first air outlet, the second lateral housing surface comprising a first air inlet; and
a fan disposed within the main body and comprising a ventilation outlet and a ventilation inlet, wherein a space layout within the main body comprises at least an air channel interconnected between the air inlet and the ventilation inlet, the air channel comprises an second air inlet and an second air outlet, wherein a cross-section of the second air inlet is smaller than a cross-section of the second air outlet.

2. The portable electronic device of claim 1, wherein the fan is a centrifugal fan.

3. The portable electronic device of claim 1, wherein the cross-section of the air channel comprises a width of at least 0.3 mm.

4. The portable electronic device of claim 1, wherein the main body comprises a bottom surface without any ventilation hole.

5. The portable electronic device of claim 1, wherein the air outlet is aligned with the ventilation outlet.

6. The portable electronic device of claim 1, further comprising a plurality of heat-generating components disposed within the main body, wherein the heat-generating components comprises a first component generating relatively more heat and a second component generating relatively less heat, the first component is closer to the air inlet than the air outlet.

7. A portable electronic device comprising:
a main body comprising two opposite first and second lateral housing surfaces, the first lateral housing surface comprising an air outlet, the second lateral housing surface comprising an air inlet;
a plurality of heat-generating components disposed within the main body;
an air guide module disposed between the heat-generating components and the air inlet to direct air to the heat-generating components; and
a fan disposed within the main body and comprising a ventilation outlet and a ventilation inlet, wherein a space layout within the main body comprises at least an air channel interconnected between the air inlet and the ventilation inlet.

8. The portable electronic device of claim 7, wherein the fan is a centrifugal fan.

9. The portable electronic device of claim 7, wherein the cross-section of the air channel comprises a width of at least 0.3 mm.

10. The portable electronic device of claim 7, wherein the main body comprises a bottom surface without any ventilation hole.

11. The portable electronic device of claim 7, wherein the heat-generating components comprises a first component generating relatively more heat and a second component generating relatively less heat, the first component is closer to the air inlet than the air outlet.

12. The portable electronic device of claim 11, wherein the first component comprises a graphics chip, a south bridge chip, a north bridge chip or a central processing chip.

13. The portable electronic device of claim 7, wherein the heat-generating components comprises a relatively thick component and a relatively thin component, the relatively thick component is closer to the air inlet than the air outlet.

14. The portable electronic device of claim 13, wherein the relatively thick component is a hard disc.

15. The portable electronic device of claim 7, wherein the air guide module comprises a guide surface.

16. The portable electronic device of claim 15, wherein the air guide surface is not in parallel with the air inlet.

17. The portable electronic device of claim 7, wherein the air outlet is aligned with the ventilation outlet.
